(19) United States
(12) Patent Application Publication
(10) Pub. No.: US 2006/0221007 A1
(43) Pub. Date: Oct. 5, 2006

(54) Organic light emitting display and method of driving the same

(76) Inventor: Eun Ah Kim, Seoul (KR)

Correspondence Address: CHRISTIE, PARKER & HALE, LLP, PO BOX 7068, PASADENA, CA, 91109-7068, US

(21) Appl. No.: 11/361,552

(22) Filed: Feb. 24, 2006

(30) Foreign Application Priority Data
Mar. 31, 2005 (KR) 10-2005-0027309

(51) Int. Cl. G09G 3/30

(52) U.S. Cl. 345/76

(57) ABSTRACT

An organic light emitting display with improved display quality. The organic light emitting display includes a display panel including red pixels having red organic light emitting diodes (OLED), green pixels having green OLEDs and blue pixels having blue OLEDs, a first divided power source connected to at least one of the red pixels, the green pixels and the blue pixels, a second divided power source connected to the pixels different from the pixels to which the first divided power source is connected, a power source generator for controlling the voltage value of the first divided power source, and a common power source commonly connected to the red pixels, the green pixels and the blue pixels.

### CROSS-REFERENCE TO RELATED APPLICATION

This application claims the benefit of and priority to Korean Patent Application No. 10-2005-0027309, filed on Mar. 31, 2005, in the Korean Intellectual Property Office, the entire content of which is incorporated herein by reference.

### BACKGROUND

1. Field of the Invention

The embodiments of the present invention relate to an organic light emitting display and a method of driving the same. More specifically, the embodiments of the invention relate to an organic light emitting display capable of improving display quality and a method of driving the same.

2. Discussion of Related Art

Recently, various flat panel displays have been developed having low weight and volume, which are advantages over the traditional cathode ray tubes (CRT). Flat panel displays technologies include liquid crystal displays (LCD), field emission displays (FED), plasma display panels (PDP) and organic light emitting displays.

The organic light emitting display includes a plurality of organic light emitting diodes (OLED) that emit light by re-combination of electrons and holes. The organic light emitting displays have high response speeds and low power consumption.

FIG. 1 illustrates a conventional organic light emitting display. The conventional organic light emitting display includes a pixel portion 30 having pixels 40 defined at the intersections between scan lines S1 to Sn and data lines D1 to Dm. The conventional organic light emitting display also includes a scan driver 10 for driving the scan lines S1 to Sn, a data driver 20 for driving data lines D1 to Dm and a timing controller 50 for controlling the scan driver 10 and the data driver 20.

The timing controller 50 generates data driving control signals DCS and scan driving control signals SCS using external synchronizing signals. The data driving control signals DCS generated by the timing controller 50 are supplied to the data driver 20 and the scan driving control signals SCS generated by the timing controller 50 are supplied to the scan driver 10. The timing controller 50 re-aligns data from external signals and outputs the data (labeled ‘Data’ in FIG. 1) to the data driver 20.

The scan driver 10 receives the scan driving control signals SCS from the timing controller 50. The scan driver 10 processes the received scan driving control signal SCS to sequentially supply scan signals to the first through nth scan lines S1 to Sn.

The data driver 20 receives the data driving control signals DCS from the timing controller 50. The data driver 20 processes the received data driving control signal DCS and generates data signals that are supplied to the data lines D1 to Dm. The data signals are supplied to the data lines D1 to Dm whenever the scan signals are supplied.

The pixel portion 30 receives first and second power from first and second power sources ELVDD and ELVSS. The voltage value of the second power source ELVSS is lower than the voltage value of the first power source ELVDD. The voltage value of the second power source ELVSS may be set as ground voltage.

Each of the pixels 40 controls the amount of current supplied from the first power source ELVDD to the second power source ELVSS via the OLED (not shown) included therein. The OLED included in each of the pixels 40 generates light of one color, red, green or blue. The pixel portion 30 combines the red pixels R that include the red OLEDs, the green pixels G that include the green OLEDs and the blue pixels B that include the blue OLEDs with one another to display color images.

Because the red OLEDs, the green OLEDs and the blue OLEDs are formed of different organic materials or phosphors, the life spans of the red, green, and blue OLEDs are different from each other. Actually, the life spans of the red and green OLEDs are similar to each other and the life span of the blue OLED is shorter than the life span of the red and green OLEDs. Therefore, when the organic light emitting displays are used for more than a predetermined period, the brightness of the blue OLEDs becomes low so that white balance deteriorates. As a result, display quality deteriorates.

### SUMMARY OF THE INVENTION

An organic light emitting display capable of improving display quality and a method of driving the same. In one embodiment of the present invention, an organic light emitting display comprises display panel that includes red pixels having red organic light emitting diodes (OLED), green pixels having green OLEDs and blue pixels having blue OLEDs. A first divided power source may be connected to at least one of the red pixels, the green pixels and the blue pixels. A second divided power source may be connected to different pixels than the first divided power source. A power source generator controls the voltage value of the first divided power source and a common power source that may be connected to the red pixels, the green pixels and the blue pixels.

In one embodiment, the first divided power source may be connected to the blue pixels and the second divided power source be connected to the red and green pixels. The power source generator may periodically increase the voltage value of the first divided power source after every predetermined time period so that the red, green and blue pixels are white-balanced. The increased voltage value of the first divided power source is higher than the voltage value of the second divided power source.

In second embodiment of the present invention, the method of driving an organic light emitting display includes controlling the amount of current that flows from a first divided power source to a common power source via blue OLEDs in response to data signals that generate blue light, controlling the amount of current that flows from a second divided power source to the common power source via red OLEDs in response to the data signals that generate red light and controlling the amount of current that flows from the second divided power source to the common power source via green OLEDs in response to the data signals that generate green light. The voltage value of the first divided power source increases by a predetermined voltage after every predetermined period. The increased voltage value of the first divided power source may be set so that displayed images are white-balanced.

In a third embodiment of the present invention, a method of driving an organic light emitting display includes controlling the amount of current that flows from a first divided power source to a common power source via blue OLEDs in response to data signals that generate blue light, controlling the amount of current that flows from a second divided power source to the common power source via red OLEDs in response to the data signals that generate red light and controlling the amount of current that flows from the second divided power source to the common power source via green OLEDs in response to the data signals that generate green light. The voltage value of the second divided power source may be periodically reduced by a predetermined voltage after every predetermined time period. The reduced voltage values of the second divided power source may be set so that displayed images are white-balanced.

In a fourth embodiment of the present invention, a method of driving an organic light emitting display includes controlling the amount of current that flows from a common power source to a first divided power source via blue OLEDs in response to data signals that generate blue light, controlling the amount of current that flows from the common power source to the second divided power source via red OLEDs in response to the data signals that generate red light and controlling the amount of current that flows from the common power source to the second divided power source via green OLEDs in response to the data signals that generate green light. The voltage value of the first divided power source may be periodically reduced by a predetermined voltage after every predetermined time period. The reduced voltage value of the first divided power source may be set so that displayed images are white-balanced.

In a fifth embodiment of the present invention, a method of driving an organic light emitting display includes controlling the amount of current that flows from a common power source to a first divided power source via blue OLEDs in response to data signals that generate blue light, controlling the amount of current that flows from the common power source to the second divided power source via red OLEDs in response to the data signals that generate red light and controlling the amount of current that flows from the common power source to the second divided power source via green OLEDs in response to the data signals that generate green light. The voltage value of the second divided power source is periodically increased by a predetermined voltage after every predetermined time period. The increased voltage values of the second divided power source may be set so that displayed images are white-balanced.

In a sixth embodiment of the present invention, an organic light emitting display includes a first set of pixels including a first set of OLEDs that emit at least one colored light, a second set of pixels including a second set of OLEDs that emit at least one colored light different from the light emitted by the first set of OLEDs, a common power source commonly connected to the first and second sets of pixels, a first divided power source connected to the first set of pixels and a second divided power source connected to the second set of pixels.

The voltage of at least one of the first divided power source and the second divided power source may change after every predetermined time period so that white-balanced images are displayed. The voltage of at least one of the first divided power source and the second divided power source increases after every predetermined time period. The voltage of at least one of the first divided power source and the second divided power source is reduced after every predetermined time period.

### BRIEF DESCRIPTION OF THE DRAWINGS

These and/or other aspects and features of the invention will become apparent and more readily appreciated from the following description of the embodiments, taken in conjunction with the accompanying drawings.

FIG. 1 illustrates a conventional organic light emitting display.

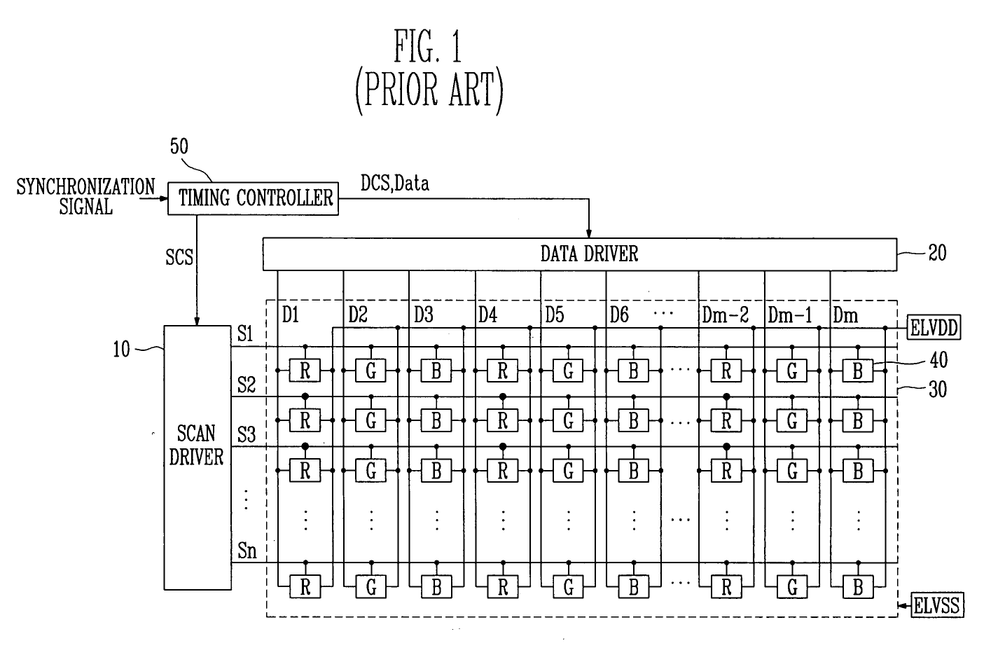

FIG. 2 illustrates an organic light emitting display according to a first embodiment of the present invention.

FIG. 3 is a circuit diagram illustrating an example of the pixel illustrated in FIG. 2.

FIG. 4 illustrates an organic light emitting display according to a second embodiment of the present invention.

FIG. 5 illustrates an organic light emitting display according to a third embodiment of the present invention.

FIG. 6 illustrates an organic light emitting display according to a fourth embodiment of the present invention.

### DETAILED DESCRIPTION

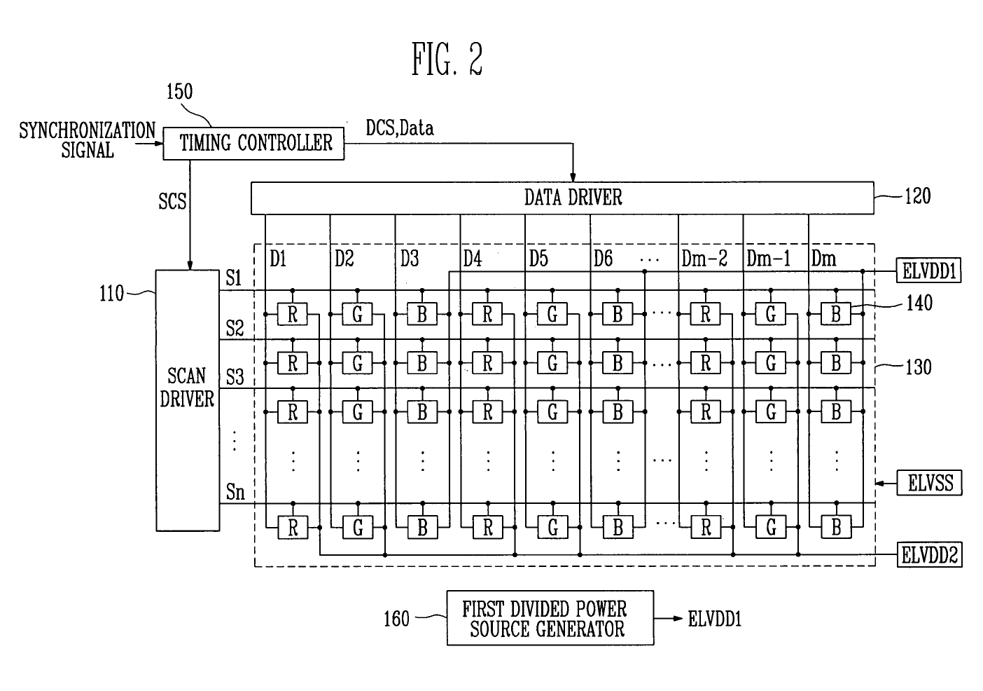

FIG. 2 illustrates an organic light emitting display according to a first embodiment of the present invention. The organic light emitting display according to the first embodiment of the present invention includes a pixel unit, which may also be referred to as a pixel portion 130, including a plurality of pixels 140 defined at the intersections between scan lines S1 to Sn and data lines D1 to Dm, a scan driver 110 for driving the scan lines S1 to Sn, a data driver 120 for driving the data lines D1 to Dm and a timing controller 150 for controlling the scan driver 110 and the data driver 120.

The timing controller 150 generates data driving control signals DCS and scan driving control signals SCS using synchronizing signals supplied from an external source. The data driving control signals DCS generated by the timing controller 150 are supplied to the data driver 120 and the scan driving control signals SCS generated by the timing controller 150 are supplied to the scan driver 110. The timing controller 150 supplies the data (labled ‘Data’ in FIG. 2) from the external source to the data driver 120.

The scan driver 110 receives the scan driving control signals SCS from the timing controller 150. The scan driver 110 processes the received scan driving control signals SCS and sequentially supplies scan signals to the first through nth scan lines S1 to Sn.

The data driver 120 receives the data driving control signals DCS from the timing controller 150. The data driver 120 processes the received data driving control signals DCS and generates data signals to be supplied to the data lines D1 to Dm. The data signals are supplied to the data lines D1 to Dm whenever the scan signals are supplied.

The pixel portion 130 receives powers from first and second divided power sources ELVDD1 and ELVDD2 and a second power source ELVSS (or a common power source). The voltage value of the second power source ELVSS is lower than the voltage values of the first and second divided power sources ELVDD1 and ELVDD2. For example, the voltage value of second power source ELVSS may be set at ground voltage.

The second divided power source ELVDD2 may be connected to the red and green pixels R and G included in the pixel portion 130. Here, the voltage value of the second divided power source ELVDD2 may be maintained at a constant value regardless of the lapse of time.

The first divided power source ELVDD1 is connected to blue pixels B included in the pixel portion 130. The voltage value of the first divided power source ELVDD1 may be changed with the lapse of time. The first divided power source generating unit 160 may provide the first divided power source ELVDD1 that periodically increases by a predetermined voltage with the lapse of time to supply the generated first divided power source ELVDD1 to the blue pixels B. The first voltage level of the divided power source ELVDD1 may be periodically increased by a predetermined amount. This first divided power source may be supplied to the blue pixels B of the pixel portion 130 so that white-balanced images, regardless of the lapse of time, are maintained.

The voltage values of the first and second divided power sources ELVDD1 and ELVDD2 may be equal to each other at an initial stage or first instance where the organic light emitting display is used. At that time the voltage values of the first and second divided power sources ELVDD1 and ELVDD2 are equal to each other and the pixel portion 130 displays white-balanced images. After the organic light emitting display is in operation for more than a predetermined time, due to the life span of the blue OLEDs, even though the same data signals are applied, the brightness of the blue pixels B diminishes from the brightness at the initial stage. The first divided power source generator 160 may generate the first divided power source ELVDD1 with a higher voltage value than the voltage value of the second divided power source ELVDD2 where the first divided power source ELVDD1 is supplied to the blue pixels B.

When the voltage value of the first divided power source ELVDD1 increases, the brightness of the blue pixels B increases so that it is possible to display white-balanced images. The first divided power source generator 160 controls the voltage value of the first divided power source ELVDD1 so that the displayed images are white-balanced. That is, according to the first embodiment of the present invention, the voltage value of the first divided power source ELVDD1 increases with the lapse of time so that it is possible to display white-balanced images. Therefore, it is possible to maintain or improve display quality.

In another embodiment, various methods may be used by the first divided power source generator 160 to generate the first divided power source ELVDD1 whose voltage value is increased periodically. For example, a user of the organic light emitting display may adjust the first divided power source generator 160 to increase the first divided power source ELVDD1 voltage so that displayed images are white-balanced at every predetermined period (for example, every year).

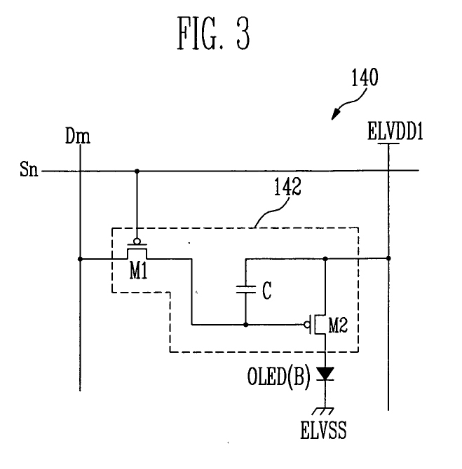

FIG. 3 illustrates an example of the pixel illustrated in FIG. 2. The pixel connected to the nth scan line Sn and the mth data line Dm is illustrated in FIG. 3 as an example pixel. The pixel 140 according to one embodiment of the present invention includes an OLED (labeled ‘OLED(B)’ in FIG. 3) a pixel circuit 142 connected to OLED (B), a data line Dm and a scan line Sn. The pixel 140 emits light from OLED (B).

The anode electrode of OLED(B) is connected to the pixel circuit 142 and the cathode electrode of OLED(B) is connected to the second power source ELVSS. OLED(B) emits light corresponding to the current supplied by the pixel circuit 142.

The pixel circuit 142 includes a second transistor M2 connected between the first divided power source ELVDD1 and OLED(B), a first transistor M1 connected to the second transistor M2, the data line Dm and the scan line Sn, and a storage capacitor C connected between the gate electrode of the second transistor M2 and the first divided power source ELVDD1.

The gate electrode of the first transistor M1 is connected to the scan line Sn. The first electrode of the first transistor M1 is connected to the data line Dm. The second electrode of the first transistor M1 is connected to one side of the storage capacitor C. The gate electrode of the second transistor M2. The first electrode is set as one of a source electrode and a drain electrode. The second electrode is set as the other one of the source electrode and the drain electrode, different from the first electrode. The first transistor M1 is turned on when the scan signal is supplied by the scan line Sn and supplies the data signal from the data line Dm to the storage capacitor C. when the scan signal is received, the voltage corresponding to the data signal is charged in the storage capacitor C.

The gate electrode of the second transistor M2 is connected to one side of the storage capacitor C. The first electrode of the second transistor M2 is connected to the first divided power source ELVDD1. The second electrode of the second transistor M2 is connected to the anode electrode of OLED(B). The second transistor M2 controls the amount of current that flows from the first divided power source ELVDD1 to OLED(B) in response to the voltage stored in the storage capacitor C. OLED(B) emits light at a brightness corresponding to the amount of current supplied by the second transistor M2.

Various methods may be used by the pixel 140 to control the brightness. For example, when the voltage of the first divided power source ELVDD1 increases, even though the same digital signals are supplied, a larger amount of current may be supplied to OLED(B) so that the brightness of the pixel 140 increases. When the voltage of the first divided power source ELVDD1 is reduced, even though the same data signals are supplied, a smaller amount of current may be supplied to OLED(B) so that the brightness of the pixel 140 is reduced. When the voltage of the second power source ELVSS increases, even though the same data signals are supplied, a smaller amount of current may be supplied to OLED(B) so that the brightness of the pixel 140 is reduced. When the voltage of the second power source ELVSS is reduced, even though the same data signals are supplied, a larger amount of current may be supplied to OLED(B) so that the brightness of the pixel 140 increases.

The structure of the pixel circuit 142 is not restricted to the embodiment of the present invention illustrated in FIG. 3. It would be understood by one skilled in the art that various circuits may be used in place of the pixel circuit 142.

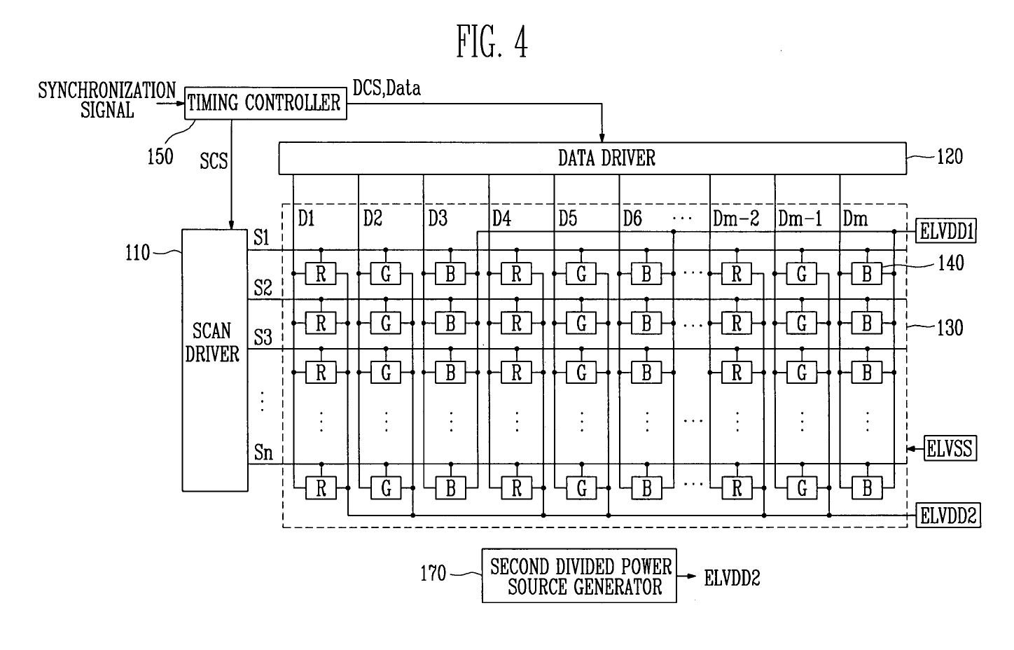

FIG. 4 illustrates an organic light emitting display according to a second embodiment of the present invention. In FIG. 4, because the same reference numerals as the reference numerals of FIG. 2 identify the same elements as the elements of FIG. 2, their description will be omitted.

Referring to FIG. 4, the organic light emitting display according to the second embodiment of the present invention includes a pixel portion 130 including a plurality of pixels 140 defined at the intersections between scan lines S1 to Sn and data lines D1 to Dm, a scan driver 110 for driving the scan lines S1 to Sn, a data driver 120 for driving the data lines D1 to Dm, and a timing controller 150 for controlling the scan driver 110 and the data driver 120.

The pixel portion 130 receives powers from first and second divided power sources ELVDD1 and ELVDD2, and a second power source ELVSS or a common power source. The voltage value of the second power source ELVSS may be lower than the voltage values of the first and second divided power sources ELVDD1 and ELVDD2. For example, the voltage value at the second power source ELVSS may be set as ground voltage. Each of the pixels 140 controls the amount of current that flows from the first divided power source ELVDD1 or the second divided power source ELVDD2 to the second power source ELVSS via an OLED in response to a data signal.

The first divided power source ELVDD1 is connected to the blue pixels B in the pixel portion 130. The first divided power source ELVDD1 may have a fixed voltage value. The voltage value of the first divided power source ELVDD1 is maintained at the same value regardless of the lapse of time.

The second divided power source ELVDD2 may be connected to the red and green pixels R and G included in the pixel portion 130.

The second divided power source generator 170 generates the second divided power source ELVDD2. The second divided power source generator 170 generates the second divided power source ELVDD2, which is reduced by a predetermined voltage after every predetermined time period. Because the second divided power source ELVDD2 is periodically reduced by the predetermined voltage over time, the pixel portion 130 can continue to display white-balanced images.

The voltage values of the first and second divided power sources ELVDD1 and ELVDD2 are equal to each other at an initial stage or first instance where the organic light emitting display is used. During this stage, the voltage values of the first and second divided power sources ELVDD1 and ELVDD2 are equal to each other and the pixel portion 130 displays white-balanced images. Then, after the organic light emitting display is in operation for more than a predetermined time, due to the life span of the blue OLEDs, even though the same data signals are applied, the brightness of the blue pixels B becomes less than the brightness at the initial stage. After adjustment, the second divided power source generator 170 generates the second divided power source ELVDD2 with a lower voltage value than the voltage value of the first divided power source ELVDD1. This reduced voltage is supplied by the generated second divided power source ELVDD2 to the red and green pixels R and G.

When the voltage value of the second divided power source ELVDD2 is reduced, the brightness of the red and green pixels R and G is reduced so that it is possible to display white-balanced images. The second divided power source generator 170 controls the voltage value of the second divided power source ELVDD2 so that the displayed images are white-balanced. That is, in the second embodiment of the present invention, the voltage value of the second divided power source ELVDD2 is reduced over time so that it is possible to display white-balanced images, thereby maintaining or improving display quality.

When the second divided power source generator 170 generates the second divided power source ELVDD2 whose voltage value is reduced, various methods may be used. For example, a user of the organic light emitting display may adjust the second divided power source generator 170 so that displayed images are white-balanced at every predetermined period (for example, every year), so that the second divided power source generator 170 generates the second divided power source ELVDD2 with a reduced voltage value.

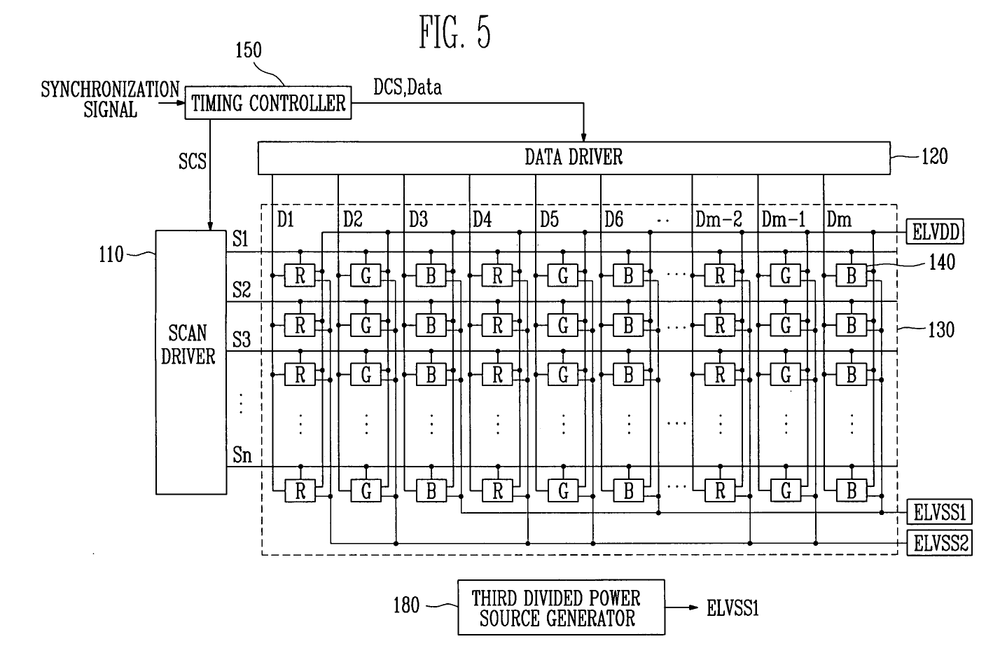

FIG. 5 illustrates an organic light emitting display according to a third embodiment of the present invention. Because the same reference numerals in FIG. 5 are used to represent the same elements as in FIG. 2, the description of matching elements will be omitted. The organic light emitting display according to the third embodiment of the present invention includes a pixel portion 130 including a plurality of pixels 140 defined at the intersections between scan lines S1 to Sn and data lines D1 to Dm, a scan driver 110 for driving the scan lines S1 to Sn, a data driver 120 for driving the data lines D1 to Dm and a timing controller 150 for controlling the scan driver 110 and the data driver 120.

The pixel portion 130 receives powers from a first power source ELVDD or a common power source and third and fourth divided power sources ELVSS1 and ELVSS2. The voltage values of the third and fourth divided power sources ELVSS1 and ELVSS2 may be lower than the voltage value of the first power source ELVDD.

Each of the pixels 140 controls the amount of current that flows from the first power source ELVDD to the third or fourth divided power source ELVSS1 or ELVSS2 via an OLED in response to a data signal. The first power source ELVDD is commonly connected to all of the pixels R, G, and B included in the pixel portion 130 to supply a predetermined current to the pixels R, G, and B.

The fourth divided power source ELVSS2 may be connected to the red and green pixels R and G included in the pixel portion 130. The voltage value of the fourth divided power source ELVSS2 may have a fixed voltage value. The voltage value of the fourth divided power source ELVSS2 may be maintained at the same level regardless of the lapse of time.

The third divided power source ELVSS1 may be connected to the blue pixels B included in the pixel portion 130. A third divided power source generator 180 generates the third divided power source ELVSS1. The third divided power source generator 180 generates the third divided power source ELVSS1, which is reduced by a predetermined voltage after every predetermined time period. Because the third divided power source ELVSS1 is reduced by the predetermined voltage over time, the pixel portion 130 can display white-balanced images.

The voltage values of the third and fourth divided power sources ELVSS1 and ELVSS2 are equal to each other at the initial stage or first instance where the organic light emitting display is used. During this stage, the voltage values of the third and fourth divided power sources ELVSS1 and ELVSS2 are equal to each other and the pixel portion 130 displays white-balanced images. After the organic light emitting display is in operation for more than a predetermined time, due to the life span of the blue OLEDs, even though the same data signals are applied, the brightness of the blue pixels B becomes less than the brightness at the initial stage. After the predetermined time, the third divided power source generator 180 provides the third divided power source ELVSS1 with a lower voltage value than the voltage value of the fourth divided power source ELVSS2. The reduced third divided power source ELVSS1 is supplied to the blue pixels B.

When the voltage value of the third divided power source ELVSS1 is reduced, the brightness of the blue pixels B increases so that it is possible to display white-balanced images. The third divided power source generator 180 controls the voltage value of the third divided power source ELVSS1 so that the displayed images are white-balanced. In the third embodiment of the present invention, the voltage value of the third divided power source ELVSS1 is reduced over time so that it is possible to display white-balanced images and thereby maintain or improve display quality.

Various methods may be used by the third divided power source generator 180 to generate the third divided power source ELVSS1 whose voltage value is reduced. For example, a user of the organic light emitting display may adjust the third divided power source generator 180 to generate the third divided power source ELVSS1 whose voltage value is reduced so that displayed images are white-balanced at every predetermined period (for example, every year).

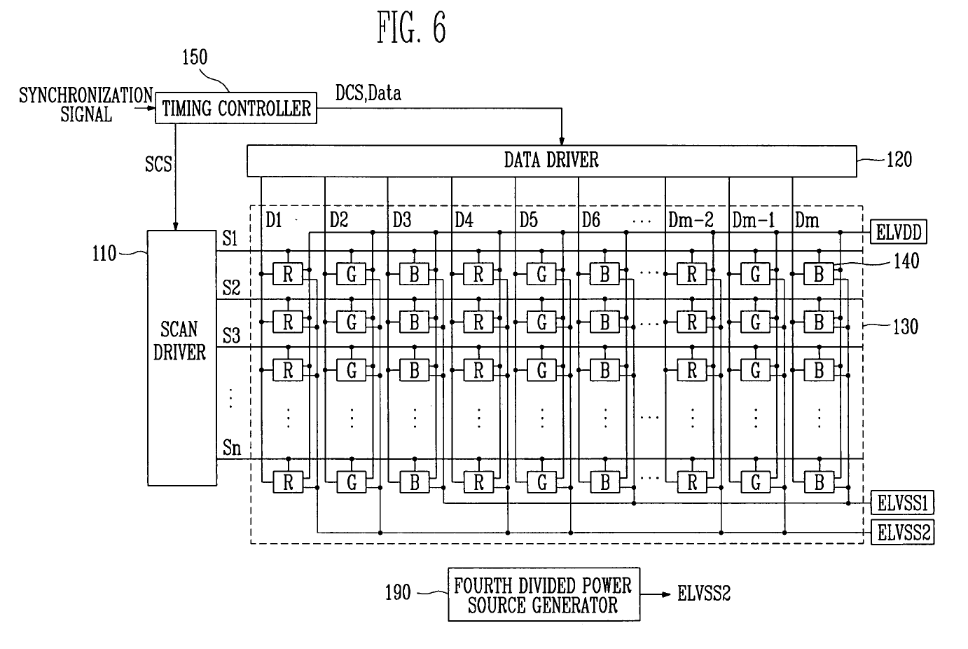

FIG. 6 illustrates an organic light emitting display according to a fourth embodiment of the present invention. Because the same reference numerals in FIG. 6 are used to represent the same elements as in FIG. 2, the description of matching elements will be omitted. The organic light emitting display in the fourth embodiment of the present invention includes a pixel portion 130 that includes a plurality of pixels 140 defined at the intersections between scan lines S1 to Sn and data lines D1 to Dm, a scan driver 110 for driving the scan lines S1 to Sn, a data driver 120 for driving the data lines D1 to Dm and a timing controller 150 for controlling the scan driver 110 and the data driver 120.

The pixel portion 130 receives powers from a first power source ELVDD or a common power source and third and fourth divided power sources ELVSS1 and ELVSS2. The voltage values of the third and fourth divided power sources ELVSS1 and ELVSS2 may be lower than the voltage value of the first power source ELVDD.

Each of the pixels 140 controls the amount of current that flows from the first power source ELVDD to the third or fourth divided power source ELVSS1 or ELVSS2 via an OLED in response to a data signal. The first power source ELVDD is commonly connected to all of the pixels R, G, and B included in the pixel portion 130 to supply a predetermined current to the pixels R, G, and B.

The third divided power source ELVSS1 may be connected to the blue pixels B included in the pixel portion 130. The voltage value of the third divided power source ELVSS1 is fixed. The voltage value of the third divided power source ELVSS1 is maintained at the same level regardless of the lapse of time. The fourth divided power source ELVSS2 may be connected to the red and green pixels R and G included in the pixel portion 130.

A fourth divided power source generator 190 provides the fourth divided power source ELVSS2. The fourth divided power source generator 190 generates the fourth divided power source ELVSS2 that increases by a predetermined voltage at every predetermined time period. Because the fourth divided power source ELVSS2 increases by the predetermined voltage over time, the pixel portion 130 can display white-balanced images.

The voltage values of the third and fourth divided power sources ELVSS1 and ELVSS2 are equal to each other at an initial stage or first instance where the organic light emitting display is used. During this stage, the voltage values of the third and fourth divided power sources ELVSS1 and ELVSS2 are equal to each other and the pixel portion 130 displays white-balanced images. After the organic light emitting display is in operation for more than a predetermined time, due to the life span of the blue OLEDs, even though the same data signals are applied, the brightness of the blue pixels B becomes less than the brightness at the initial stage. The fourth divided power source generator 190 generates the fourth divided power source ELVSS2 which has a higher voltage value than the voltage value of the third divided power source ELVSS1 and supplies the generated fourth divided power source ELVSS2 to the blue pixels B.

After the predetermined time, the voltage value of the fourth divided power source ELVSS2 is higher than the voltage value of the third divided power source ELVSS1 and the brightness of the red and green pixels R and G is reduced so that white-balanced images are displayed. The fourth divided power source generator 190 controls the voltage value of the fourth divided power source ELVSS2 so that the displayed images are white-balanced. In the fourth embodiment of the present invention, the voltage value of the fourth divided power source ELVSS2 increases over time to display white-balanced images and thereby maintain and improve display quality.

Various methods may be used by the fourth divided power source generator 190 to generate the fourth divided power source ELVSS2 whose voltage value is reduced. For example, a user of the organic light emitting display may adjust the fourth divided power source generator 190 to generate the fourth divided power source ELVSS2 whose voltage value is increased so that displayed images are white-balanced at every predetermined period (for example, every year).

In one embodiment of the present invention, two or more driving schemes of the organic light emitting displays in the first to fourth embodiments of the present invention illustrated in FIGS. 2, 4, 5, and 6 may be simultaneously applied. For example, in one embodiment of the present invention, the voltage of the power sources connected to the blue pixels B to supply currents may be increased and, at the same time, the voltage of the power sources connected to the red and green pixels R and G to receive currents may be increased to display white-balanced images.

As described above, in the organic light emitting display of the embodiments of the present invention and the method of driving the same, the voltage value of the first power source connected to the anode electrode of the blue OLED may be increased or the voltage value of the second power source connected to the cathode electrode of the blue OLED may be reduced to display white-balanced images regardless of the life spans of the OLEDs. In one embodiment of the present invention, the voltage value of the first power source connected to the red and green OLEDs may be reduced or the voltage value of the second power source connected to the red and green OLEDs may be increased to display white-balanced images regardless of the life spans of the OLEDs.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An organic light emitting display comprising:
a display panel including red pixels having red organic light emitting diodes (OLED), green pixels having green OLEDs and blue pixels having blue OLEDs;
a first divided power source connected to any one the red pixels, the green pixels and/or the blue pixels;
a second divided power source connected to any one pixel different from pixels to which the first divided power source is connected;
a power source generator for controlling a voltage value of the first divided power source; and
a common power source commonly connected to the red pixels, the green pixels and the blue pixels.

2. The organic light emitting display of claim 1, further comprising:
a data driver for driving data lines connected to the red pixels, the green pixels and the blue pixels; and
a scan driver for driving scan lines connected to the red pixels, the green pixels and the blue pixels.

3. The organic light emitting display of claim 2, wherein the red pixels, green pixels and blue pixels control an amount of current supplied from the first divided power source or the second divided power source to the common power source via OLEDs in response to data signal's supplied to the data lines.

4. The organic light emitting display of claim 3,
wherein the first divided power source is connected to the blue pixels, and
wherein the second divided power source is connected to the red pixels and the green pixels.

5. The organic light emitting display of claim 4, wherein the power source generator increases a voltage value of the first divided power source at every predetermined time period to maintain a white-balance of the red pixels, the green pixels and the blue pixels.

6. The organic light emitting display of claim 5, wherein an increased voltage value of the first divided power source is higher than a voltage value of the second divided power source.

7. The organic light emitting display of claim 3,
wherein the first divided power source is connected to the red pixels and green pixels, and
wherein the second divided power source is connected to the blue pixels.

8. The organic light emitting display of claim 7, wherein the power source generator reduces a voltage value of the first divided power source at every predetermined time period to maintain a white-balance of the red pixels, the green pixels, and the blue pixels.

9. The organic light emitting display of claim 8, wherein a reduced voltage value of the first divided power source is lower than a voltage value of the second divided power source.

10. The organic light emitting display of claim 2, wherein the red pixels, the green pixels and the blue pixels control an amount of current supplied from the common power source to the first divided power source or the second divided power source via OLEDs in response to data signals supplied to the data lines.

11. The organic light emitting display of claim 10,
wherein the first divided power source is connected to the blue pixels, and
wherein the second divided power source is connected to the red pixels and the green pixels.

12. The organic light emitting display of claim 11, wherein the power source generator reduces a voltage value of the first divided power source at every predetermined time period so that the red pixels, the green pixels and the blue pixels are white-balanced.

13. The organic light emitting display of claim 12, wherein a reduced voltage value of the first divided power source is lower than a voltage value of the second divided power source.

14. The organic light emitting display of claim 10,
wherein the first divided power source is connected to the red pixels and the green pixels, and
wherein the second divided power source is connected to the blue pixels.

15. The organic light emitting display of claim 14, wherein the power source generator increases a voltage value of the first divided power source at every predetermined time period to maintain a white-balance of the red pixels, the green pixels and the blue pixels.

16. The organic light emitting display of claim 15, wherein an increased voltage value of the first divided power source is higher than a voltage value of the second divided power source.

17. A method of driving an organic light emitting display, the method comprising:
controlling an amount of current that flows from a first divided power source to a common power source via blue organic light emitting diodes (OLEDs) in response to data signals to generate blue light;
controlling an amount of current that flows from a second divided power source to the common power source via red OLEDs in response to the data signals to generate red light; and
controlling an amount of current that flows from the second divided power source to the common power source via green OLEDs in response to the data signals to generate green light,
wherein a voltage value of the first divided power source increases by a predetermined voltage after every predetermined time period.

18. The method of claim 17, wherein an increased voltage value of the first divided power source maintains white-balance for displayed images.

19. A method of driving an organic light emitting display, the method comprising:
controlling an amount of current that flows from a first divided power source to a common power source via blue OLEDs in response to data signals to generate blue light;
controlling an amount of current that flows from a second divided power source to the common power source via red OLEDs in response to data signals to generate red light; and
controlling an amount of current that flows from the second divided power source to the common power source via green OLEDs in response to data signals to generate green light,
wherein a voltage value of the second divided power source is reduced by a predetermined voltage after a predetermined period time.

20. The method of claim 19, wherein reduced voltage values of the second divided power source maintains white-balance for displayed images.

21. A method of driving a organic light emitting display, the method comprising:
controlling an amount of current that flows from a common power source to a first divided power source via blue OLEDs in response to data signals to generate blue light;
controlling an amount of currents that flow from the common power source to the second divided power source via red OLEDs in response to data signals to generate red light; and
controlling an amount of current that flows from the common power source to the second divided power source via green OLEDs in response to data signals to generate green light,
wherein a voltage value of the first divided power source is reduced by a predetermined voltage after a predetermined time period.

22. The method of claim 21, wherein a reduced voltage value of the first divided power source is set to maintain white-balance for displayed images.

23. A method of driving a organic light emitting display, the method comprising:
controlling an amount of current that flows from a common power source to a first divided power source via blue OLEDs in response to data signals to generate blue light;
controlling an amount of current that flows from the common power source to the second divided power source via red OLEDs in response to data signals to generate red light; and
controlling an amount of current that flows from the common power source to the second divided power source via green OLEDs in response to data signals to generate green light,
wherein a voltage value of the second divided power source is increased by a predetermined voltage after a predetermined time period.

24. The method of claim 23, wherein an increased voltage value of the second divided power source is set to maintain a white-balance for displayed images.

25. An organic light emitting display comprising:
first pixels including first OLEDs that emit at least one colored light;
second pixels including second OLEDs that emit at least one colored light different from the at least one colored light emitted by the first OLEDs;
a common power source commonly connected to the first pixels and second pixels;
a first divided power source connected to the first pixels; and
a second divided power source connected to the second pixels.

26. The organic light emitting display of claim 25, wherein a voltage of the first divided power source or the second divided power source changes after a predetermined time period to white-balance displayed images.

27. The organic light emitting display of claim 26, wherein the voltage of the first divided power source and the second divided power source increases after a predetermined time period.

28. The organic light emitting display as claimed in claim 26, wherein the voltage of the first divided power source and the second divided power source is reduced after a predetermined time period.
